(19) United States
(12) Patent Application Publication
(10) Pub. No.: US 2012/0166494 A1
(43) Pub. Date: Jun. 28, 2012

(54) COMPUTER READABLE MEDIUM AND INFORMATION PROCESSING APPARATUS

(75) Inventor: Kazuto HAYASHI, Kanagawa (JP)

(73) Assignee: FUJI XEROX CO., LTD.

(21) Appl. No.: 13/087,891

(22) Filed: Apr. 15, 2011

(30) Foreign Application Priority Data
Dec. 24, 2010 (JP) 2010-288600

(51) Int. Cl. G06F 17/30

(52) U.S. Cl. 707/803; 707/E17.044

(57) ABSTRACT

A computer readable medium stories a program causing a computer to execute a process for information processing. The process includes acquiring first data, generating first structure data based on the first data, generating substructure data, acquiring second data, generating second structure data based on the second data, generating structure data based on the substructure data, and determining whether the structure is included in the second structure.

### CROSS-REFERENCE TO RELATED APPLICATIONS

This application is based upon and claims priority under 35 USC 119 from Japanese Patent Application No. 2010-288600, filed Dec. 24, 2010.

### BACKGROUND

1. Technical Field

The present invention relates to a computer readable medium and an information processing apparatus.

2. Summary of the Invention

According to an aspect of the invention, a computer readable medium stories a program causing a computer to execute a process for information processing. The process includes acquiring first data which include first events of interest from a storage unit storing data which include events occurring in relation to each person and the occurrence time of the event, generating first structure data based on the first data using the occurrence time of the first events of interest included in the first data as a first reference time, wherein the first structure data represent a first structure which is a structure including a first relation information group and an event information group, and in which the relation information has an ancestor/descendant relation with other relation information, and the relation information becomes an ancestor of event information representing an event which occurred on with the first reference time and a period in which the event has the relation represented by the relation information, among the events included in the first data excluding the first events of interest, generating substructure data representing substructures which are included in the first structure represented by the first structure data, acquiring second data which are data which do not include the first events of interest and which include a second event of interest which is an event represented by event information selected from the event information included in the substructures, generating second structure data based on the second data using the occurrence time of the second event of interest included in the second data as a second reference time, wherein the second structure data represent a second structure which is a structure including a second relation information group different from the first relation information group and an event information group, and in which the relation information has an ancestor/descendant relation with other relation information, and the relation information becomes an ancestor of event information representing an event which occurred on the first reference time and in a period in which the event has the relation represented by the relation information, among the events included in the second data, generating structure data based on the substructure data, wherein the structure data represent a structure including relation information included in the second relation information group and event information included in the substructures, and in which the relation information has an ancestor/descendant relation with other relation information, and the relation information becomes an ancestor of event information representing an event which occurred in a period in which the event has the relation represented by the relation information with the occurrence time of the second event of interest included in the first data, and determining whether the structure represented by the structure data is included in the second structure.

### BRIEF DESCRIPTION OF THE DRAWINGS

Exemplary embodiments of the invention will be described in detail based on the following figures, wherein:

FIG. 1 is a diagram illustrating a configuration of an information processing apparatus according to an exemplary embodiment of the invention;

FIG. 2 is a diagram illustrating case data;

FIG. 3 is a flowchart illustrating a process executed by a control section;

FIG. 4 is a diagram illustrating a first structure;

FIG. 5 is a diagram illustrating an example of substructure data;

FIG. 6 is a diagram illustrating a modified substructure; and

FIG. 7 is a diagram illustrating a second structure.

### DETAILED DESCRIPTION

Hereinafter, an example of the exemplary embodiment of the invention will be described in detail with reference to the drawings.

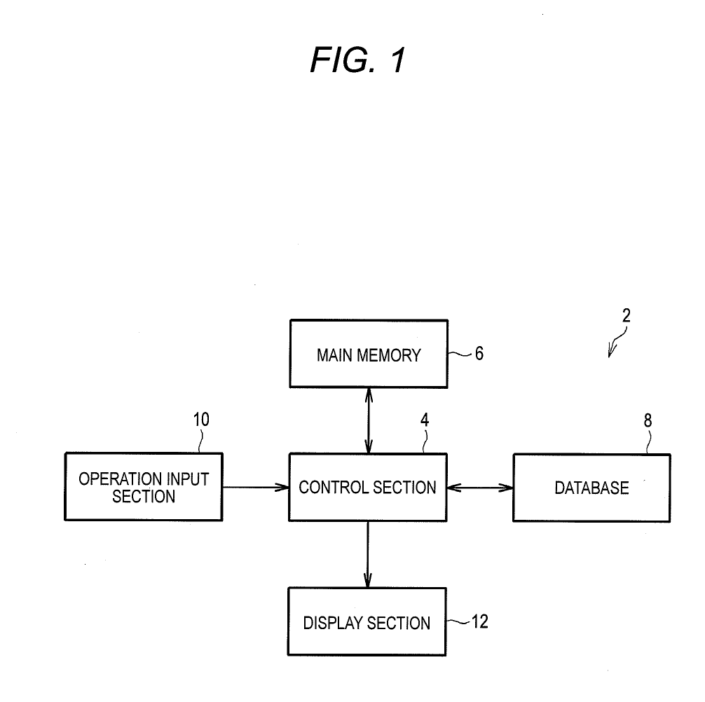

FIG. 1 is a diagram illustrating a configuration of an information processing apparatus 2 according to the exemplary embodiment of the invention. The information processing apparatus 2 is a server, for example, and as shown in FIG. 1, includes a control section 4, a main memory 6, a database 8, an operation input section 10, and a display section 12. In the present exemplary embodiment, the information processing apparatus 2 is provided in a hospital and used by a doctor, a nurse, a manager and a consultant, for example.

The control section 4 is a microprocessor, for example, and executes information processing in accordance with a program stored in the main memory 6.

The main memory 6 includes a RAM and a ROM. The program is stored in the main memory 6. The program may be read from a computer-readable information storage medium such as a DVD(TM)-ROM and stored in the main memory 6, and may be supplied from a communication link such as a network and stored in the main memory 6.

Moreover, various types of data necessary during the information processing are also stored in the main memory 6.

The database 8 is a hard disk, for example. The database (storage unit) stores case data (data) of each of a plurality of stomach cancer patients (persons), for example. Here, the case data include an event occurring in relation to a stomach cancer patient and the occurrence time of the event.

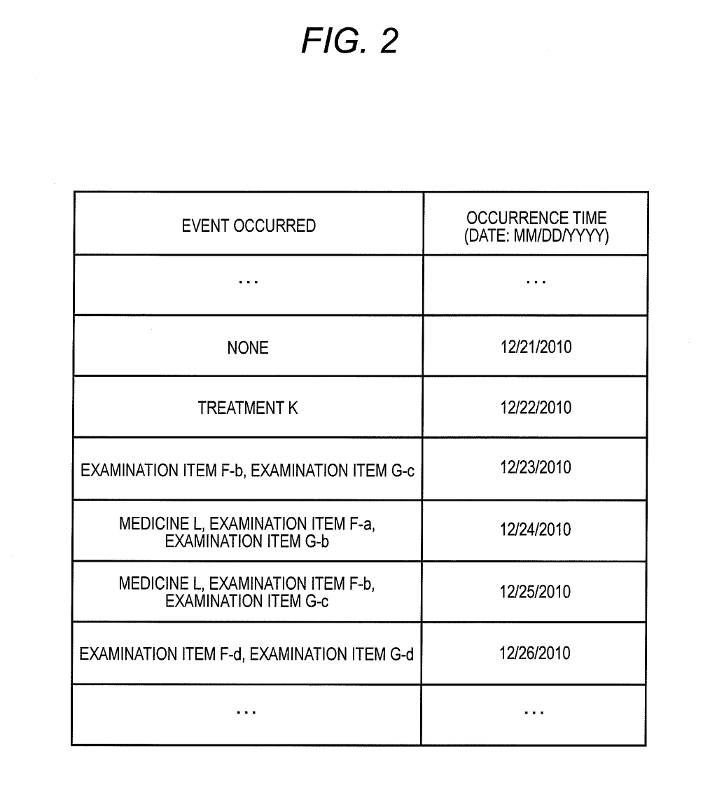

FIG. 2 illustrates case data (corresponding to first data) of a certain stomach cancer patient (described as a stomach cancer patient X). Here, a “treatment K” represents that an event “a medical treatment K is conducted for a stomach cancer patient X” occurs. Moreover, an “examination item F-b” represents that an event “an evaluation b is obtained for an examination item F” occurs. Moreover, an “examination item G-c” represents that an event “an evaluation c is obtained for an examination item G” occurs. Moreover, a “medicine L” represents that an event “a medicine L is administered to the stomach cancer patient X” occurs. Moreover, an “examination item F-a” represents that an event “an evaluation a is obtained for an examination item F” occurs. Moreover, an “examination item G-b” represents that an event “an evaluation b is obtained for an examination item G” occurs. Moreover, an “examination item F-d” represents that an event “an evaluation d is obtained for an examination item F” occurs. Moreover, an “examination item G-d” represents that an event “an evaluation d is obtained for an examination item G” occurs.

The event “an evaluation d is obtained for an examination item F” and the event “an evaluation d is obtained for an examination item G” are events that are highly associated with the occurrence of a complication. If the two events occur on the same date, it is highly likely that a complication will occur on that date.

The database 8 may be a database server that is provided to be separated from the information processing apparatus 2.

The operation input section 10 is a keyboard, a mouse, and the like, for example. The operation input section 10 outputs information representing the content of an operation performed by a physician to the control section 4. Moreover, the display section 12 is a liquid crystal display, for example. The display section 12 displays the information input from the control section 4.

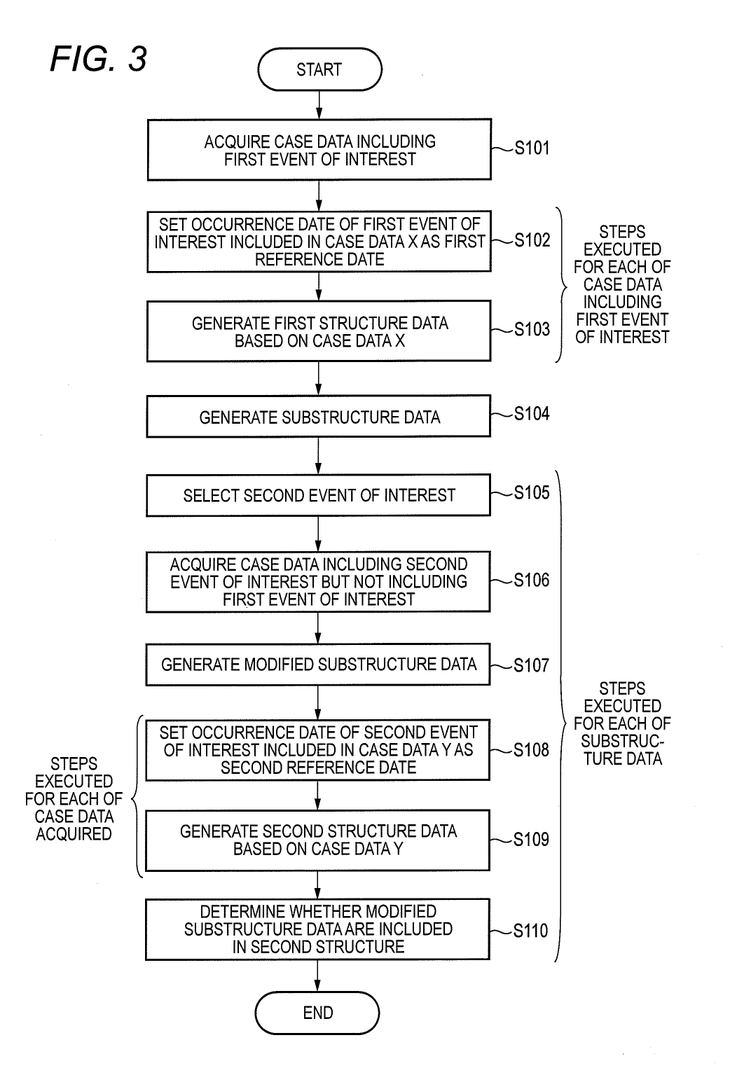

FIG. 3 is a flowchart illustrating a process executed by the control section 4 in accordance with the program.

Hereinafter, the process executed by the control section 4 will be described.

The control section 4 (first data acquisition unit) sets certain events as first events of interest based on an physician's instruction and acquires case data including the first events of interest from the database 8 (S101). In the present exemplary embodiment, the event “an evaluation d is obtained for an examination item F” and the event “an evaluation d is obtained for an examination item G” are set as the first events of interest, and case data of a case in which the two events occur on the same date are acquired from the database 8. Therefore, the case data (first data) shown in FIG. 2 are acquired.

Moreover, the control section 4 (first structure data generation section) executes the processes of steps S102 and S103 with respect to each one of the acquired case data. In the following description, case data subjected to processing are referred to as case data X, and the process of steps 5102 and S103 is described.

That is, first, the control section 4 sets the occurrence date of the first events of interest included in the case data X as a first reference date (first reference time) (S102). As a result, when the case data shown in FIG. 2 are the case data X, the occurrence date Dec. 26, 2010 (mm/dd/yyyy) of the “examination item F-d” and “examination item G-d” which are the first events of interest is set as the first reference date (see FIG. 2).

Moreover, the control section 4 generates first structure data that represent a first structure in accordance with first structuring rules described below (S103). The first structure includes a first relation node group and an event node group which includes a plurality of event nodes. The first relation node group includes a relation node assigned with a label “within 7 days before”, a relation node assigned with a label “within 5 days before”, a relation node assigned with a label “within 4 days before”, a relation node assigned with a label “within 3 days before”, a relation node assigned with a label “within 2 days before”, and a relation node assigned with a label “within 1 day before”. In the present exemplary embodiment, the first structure is a tree structure.

The first structuring rules will be described below.

(1) A relation node has an ancestor/descendant relation with other relation nodes.

(2) A relation node becomes an ancestor node of an event node representing an event which occurred on the first reference date and in a period represented by the relation node, among the events included in the case data X other than the first events of interest. For example, the relation node “within 7 days before” becomes an ancestor node of an event node representing an event which occurred in a period within 7 days before the first reference date.

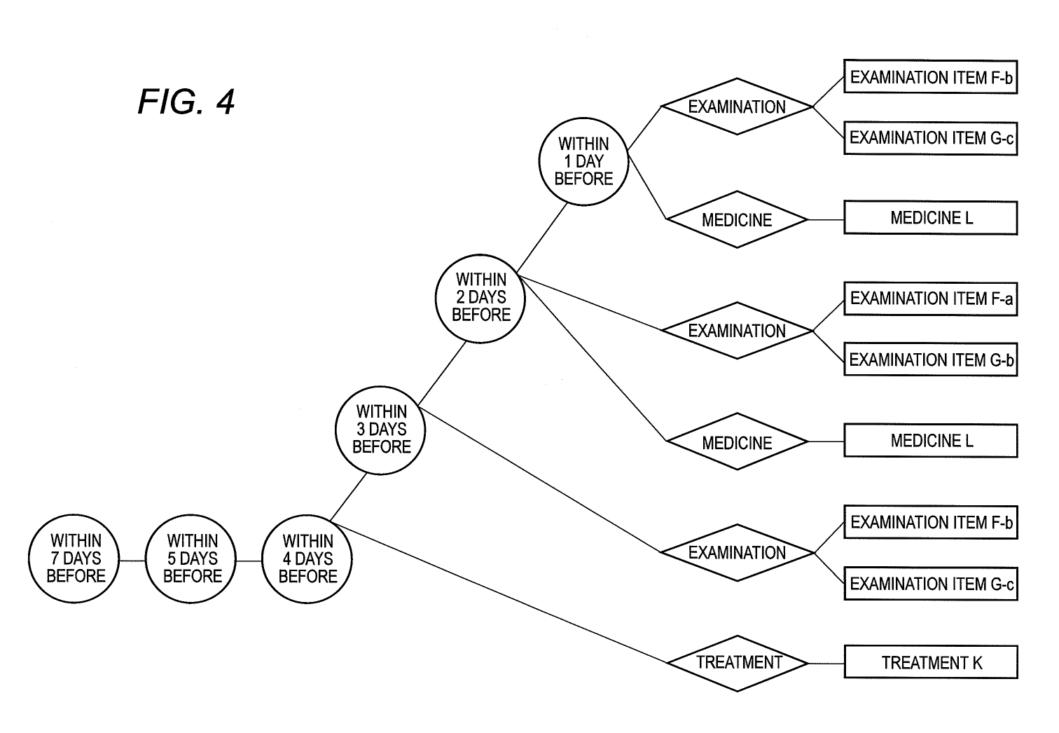

FIG. 4 illustrates a first structure represented by the first structure data which are generated from the case data (first data) shown in FIG. 2. Circular nodes represent relation nodes. Moreover, rectangular nodes represent event nodes.

As shown in the figure, the relation node has an ancestor/descendant relation with other relation nodes. Moreover, the relation node “within 1 day before” becomes an ancestor node of respective event nodes representing the events “examination item F-b”, “examination item G-c”, and “medicine L” which occurred within 1 day before the first reference date. Moreover, the relation node “within 2 days before” becomes an ancestor node of respective event nodes representing the events “examination item “F-a”, “examination item G-b”, and “medicine L” which occurred within 2 days before the first reference date, and the events “examination item F-b”, “examination item G-c”, and “medicine L” which occurred within 1 day before the first reference date. In this example, although the event nodes are connected indirectly to the relation node through a diamond-shaped node representing the type of an event, the event nodes may be connected to the relation node. Moreover, a node other than these nodes may be included in the first structure.

In this way, the control section 4 generates the first structure data from the respective case data acquired in step S101.

When the first structure data are generated in this way, the control section 4 (substructure data generation unit) extracts substructures, namely subtrees included in a predetermined number of first structures or more among a plurality of first structures represented by the respective first structure data and generates substructure data representing the substructure (S104). Extraction of substructures is performed, for example, in accordance with a subtree extraction algorithm for embedded subtree mining such as TreeMiner. Extraction of substructures may be performed in accordance with a so-called FreQT algorithm.

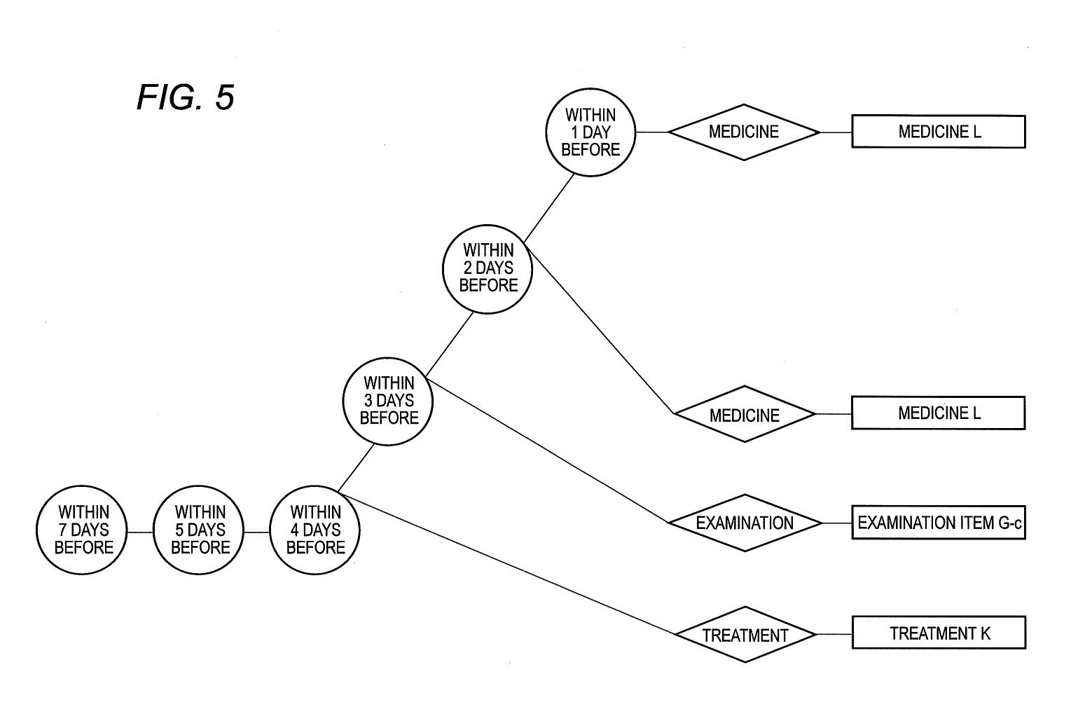

FIG. 5 illustrates an example of substructure data generated when substructures included in the first structure represented by the first structure data shown in FIG. 4 are extracted.

Through step S104, a number of substructure data corresponding to the number of extracted substructures are generated.

Moreover, the control section 4 executes the process of steps S105 to S110 for each of the substructure data. Through execution of this process, it is determined whether an occurrence pattern of an event represented by the substructure data occurs in case data which do not include the first events of interest. The result of this determination is provided to the prediction of contribution of the occurrence pattern to the occurrence of a complication.

Here, when determining whether the occurrence pattern occurs in case data which do not include the first events of interest, a method may be used in which, similarly to steps S102 and S103, the first structure data are generated from the case data, and it is determined whether substructures are included in a first structure represented by the generated first structure data.

However, since the first events of interest are not included in case data which do not include the first events of interest, it may not be possible to set the first reference date. Therefore, a method may be used in which the first structure data are generated using each one of the dates included in the case data which do not include the first events of interest, as the first reference date, and then, it is determined whether substructures are included in the first structure represented by the first structure data.

However, in this method, it is necessary to generate the first structure data a number of times, and a processing load increases.

In contrast, in the information processing apparatus 2, the processing load necessary for determination of the occurrence of an occurrence pattern represented by the substructure data is reduced. In the following description, substructure data subjected to processing are referred to as substructure data X, and the process of steps S105 to S110 is described. Moreover, in this example, a case in which the substructure data shown in FIG. 5 are used as the substructure data X will be described. This process may be performed on part of substructure data.

First, the control section 4 selects a second event of interest from events included in a substructure (hereinafter referred to as a substructure X) represented by the substructure data X (S105). For example, the control section 4 selects an event having the highest priority as the second event of interest. In this example, “initial administration of medicine L” is selected as the second event of interest (see FIG. 5).

Moreover, the control section 4 (second data acquisition unit) acquires case data (hereinafter referred to as second case data) including the second event of interest among the case data which do not include the first events of interest from the database 8 (S106).

Moreover, the control section 4 (structure data generation unit) generates modified substructure data representing a modified substructure based on the substructure data X in accordance with modification rules described below (S107). Here, the modified substructure is a structure obtained by modifying the substructure X and includes the event nodes included in the substructure X and a second relation node group. The second relation node group includes a relation node assigned with a label “between 7 days before and 1 day after”, a relation node assigned with a label “between 5 days before and 1 day after”, a relation node assigned with a label “between 4 days before and 1 day after”, a relation node assigned with a label “between 3 days before and 1 day after”, a relation node assigned with a label “between 2 days before and 1 day after”, and a relation node assigned with a label “between 1 day before and 1 day after”, a relation node assigned with a label “between 0 days before and 1 day after”, and a relation node assigned with a label “within 1 day after”,

The modification rules will be described below.

(1) A relation node has an ancestor/descendant relation with other relation nodes.

(2) A relation node becomes an ancestor node of an event node representing an event which occurred on the occurrence date of the second event of interest included in the case data used as the basis of the generation of the substructure data X and in a period in which the event has the relation represented by the relation node, among the event nodes included in the substructure X.

For example, when the substructure data X is the substructure data shown in FIG. 5, since the case data (the first data) shown in FIG. 2 are case data which are used the basis of the generation of the substructure data X, the occurrence date of the second event of interest is Dec. 24, 2010 (see FIG. 2). Therefore, the relation node “within 1 day after” becomes an ancestor node of an event node representing an event which occurred in a period within 1 day after Dec. 24, 2010.

In this example, although the modified substructure data are generated with reference to the case data which are used as the basis of the generation of the substructure data X, the modified substructure data may be generated by any method as long as it obeys the modification rules. For example, the modified substructure data may be generated based on data which represent correspondence between a relation node included in the first relation node group and a relation node included in the second relation node group.

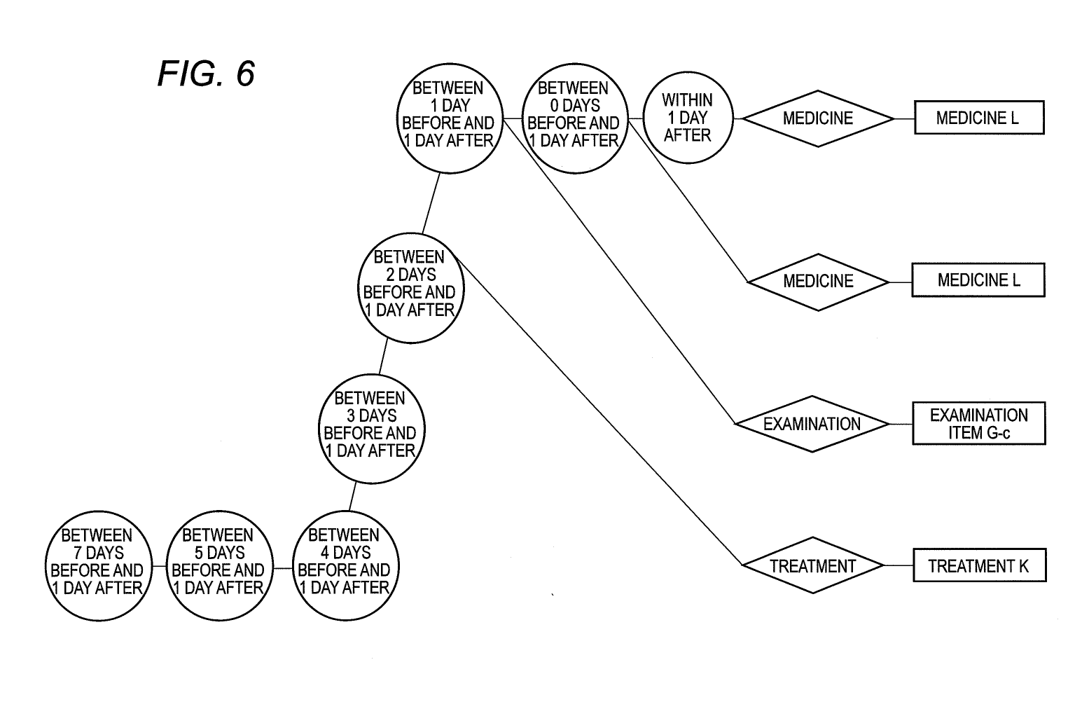

FIG. 6 illustrates a modified substructure represented by the modified substructure data (structure data).

The control section 4 may change the second relation node group in accordance with the position of the second event of interest in the substructure X. For example, in the case of FIG. 5, when “examination item G-c” is selected as the second event of interest, a relation node group including a relation node assigned with a label “between 5 days before and 2 days after”, a relation node assigned with a label “between 4 days before and 2 days after”, a relation node assigned with a label “between 3 days before and 2 days after”, a relation node assigned with a label “between 2 days before and 2 days after”, a relation node assigned with a label “between 1 day before and 2 days after”, a relation node assigned with a label “between 0 days before and 2 days after”, a relation node assigned with a label “between 1 and 2 days after”, and a relation node assigned with a label “within 2 days after” may be used as the second relation node group.

When the modified substructure data are generated in this way, the control section 4 executes the process of steps S108 and S109 for each one of the case data (the second data) acquired in step S106. Hereinafter, the case data subjected to processing will be referred to as case data Y, and the process of steps S108 and S109 will be described.

First, the control section 4 sets the occurrence date of the second event of interest included in the case data Y (the second data) as a second reference date (S108).

Moreover, the control section 4 (second structure data generation unit) generates second structure data representing second structures including the second relation node group and an event node group including a plurality of event nodes based on the case data Y in accordance with second structuring rules described below (S109). In the present exemplary embodiment, the second structure is a tree structure.

The second structuring rules will be described below.

(1) A relation node has an ancestor/descendant relation with other relation nodes.

(2) A relation node becomes an ancestor node of an event node representing an event which occurred on the second reference date and in a period in which the event has the relation represented by the relation node, among the events included in the case data Y. For example, the relation node “between 7 days before and 1 day after” becomes an ancestor node of an event representing an event which occurred in a period between 7 days before and 1 day after the second reference date.

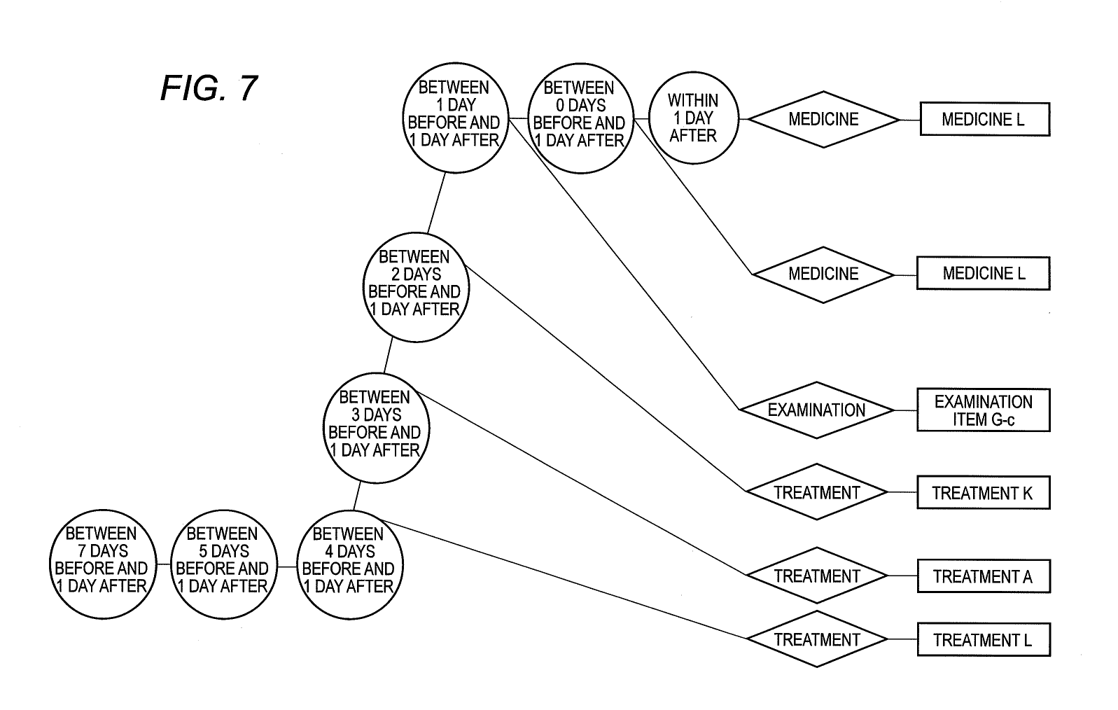

FIG. 7 illustrates an example of the second structures represented by the second structure data which are generated from the case data Y (the second data).

As described above, the same relation nodes are used in the modified substructure and the second structures. Therefore, it is possible to determine whether the modified substructure is included in the second structures. Moreover, a part, rather than the entirety, of the relation nodes included in the second structures may be included in the modified structure.

In this way, when the second structure data are generated from each one of the case data acquired in S106, the control section 4 (determination unit) determines whether the modified substructure is included in the second structures represented by the second structure data for each one of the second structure data (S110).

After that, the control section 4 performs the same process as that in steps S108 and S109 for each one of the case data acquired in step S101 to thereby generate third structure data representing third structures including the second relation node group and an event node group including a plurality of event nodes and determine whether the modified substructure is included in the third structures represented by the third structure data for each one of the third structure data. Moreover, the control section 4 calculates the number of third structures including the modified substructure and the number of second structures including the modified substructure and outputs the calculated numbers.

The embodiment of the invention is not limited to the exemplary embodiments described above.

### Modification

For example, the control section 4 may perform the process of first to third steps described below instead of step S107.

In this modification, in the first step subsequent to step S106, the control section 4 acquires case data including the first events of interest and the second event of interest. Subsequently, in the second step, the control section 4 performs the same process as that in steps S108 and S109 for each one of the case data acquired in the first step to thereby generate the second structure data for each one of the case data. After that, in the third step, the control section 4 detects a substructure which is included a predetermined number of times or more among the second structure data generated in the second step and generates substructure data representing the substructure, and the flow proceeds to the steps subsequent to S108. The substructure detected in the third step may be selected in accordance with other criteria such as a predetermined proportion or percentage in the second structure data.

After that, in step S110, the controller 4 determines whether the substructure represented by the substructure data generated in the third step is included in the second structures represented by the second structure data generated in step S109 with respect to each one of the substructures.

### Others

Moreover, for example, the process of steps S105 to S110 may not always be performed on all substructure data. for example, the control section 4 may evaluate each one of the generated substructure data in accordance with predetermined evaluation criteria and may perform the process of steps S105 to S110 for each one of the substructure data of which the evaluation scores are ranked on the first to N-th (N is an integer) highest ranks.

Furthermore, a plurality of second events of interest may be selected. For example, two second events of interest may be selected. In this case, a relation node group including one or plural relation nodes representing the relation with the occurrence date of one of the two second events of interest and one or plural relation nodes representing the relation with the occurrence date of the other second event of interest may be used as the second relation node group.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

### DESCRIPTION OF REFERENCE NUMERALS AND SIGNS

2: INFORMATION PROCESSING APPARATUS
4: CONTROL SECTION
6: MAIN MEMORY
8: DATABASE
10: OPERATION INPUT SECTION
12: DISPLAY SECTION

What is claimed is:

1. A computer readable medium storing a program causing a computer to execute a process for information processing, the process comprising:
acquiring first data which include first events of interest from a storage unit storing data which include events occurring in relation to each person and the occurrence time of the event;
generating first structure data based on the first data using the occurrence time of the first events of interest included in the first data as a first reference time, wherein the first structure data represent a first structure which is a structure including a first relation information group and an event information group, and in which the relation information has an ancestor/descendant relation with other relation information, and the relation information becomes an ancestor of event information representing an event which occurred on with the first reference time and a period in which the event has the relation represented by the relation information, among the events included in the first data excluding the first events of interest;
generating substructure data representing substructures which are included in the first structure represented by the first structure data;
acquiring second data which are data which do not include the first events of interest and which include a second event of interest which is an event represented by event information selected from the event information included in the substructures;
generating second structure data based on the second data using the occurrence time of the second event of interest included in the second data as a second reference time, wherein the second structure data represent a second structure which is a structure including a second relation information group different from the first relation information group and an event information group, and in which the relation information has an ancestor/descendant relation with other relation information, and the relation information becomes an ancestor of event information representing an event which occurred on the first reference time and in a period in which the event has the relation represented by the relation information, among the events included in the second data;
generating structure data based on the substructure data, wherein the structure data represent a structure including relation information included in the second relation information group and event information included in the substructures, and in which the relation information has an ancestor/descendant relation with other relation information, and the relation information becomes an ancestor of event information representing an event which occurred in a period in which the event has the relation represented by the relation information with the occurrence time of the second event of interest included in the first data; and
determining whether the structure represented by the structure data is included in the second structure.

2. The computer readable medium according to claim 1,
generating third structure data based on the first data using the occurrence time of the second event of interest included in the first data as a reference time, wherein the third structure data represent a third structure including the second relation information group and an event information group, and in which the relation information has an ancestor/descendant relation with other relation information, and the relation information becomes an ancestor of event information representing an event which occurred on the reference time and in a period in which the event has the relation represented by the relation information, among the events included in the first data; and
determining whether the structure represented by the structure data is included in the third structure.

3. The computer readable medium according to claim 1,
wherein, in the second structure data generating step, the second relation information group is changed in accordance with the position in the substructure, of event information selected from the event information included in the substructures.

4. An information processing apparatus comprising:
a first data acquisition unit that acquires first data which include first events of interest from a storage unit storing data which include events occurring in relation to each person and the occurrence time of the event;
a first structure data generation unit that generates first structure data based on the first data using the occurrence time of the first events of interest included in the first data as a first reference time, wherein the first structure data represent a first structure which is a structure including a first relation information group and an event information group, and in which the relation information has an ancestor/descendant relation with other relation information, and the relation information becomes an ancestor of event information representing an event which occurred on with the first reference time and a period in which the event has the relation represented by the relation information, among the events included in the first data excluding the first events of interest;
a substructure data generation unit that generates substructure data representing substructures which are included in the first structure represented by the first structure data;
a second data acquisition unit that acquires second data which are data which do not include the first events of interest and which include a second event of interest which is an event represented by event information selected from, the event information included in the substructures;
a second structure data generation unit that generates second structure data based on the second data using the occurrence time of the second event of interest included in the second data as a second reference time, wherein the second structure data represent a second structure which is a structure including a second relation information group different from the first relation information group and an event information group, and in which the relation information has an ancestor/descendant relation with other relation information, and the relation information becomes an ancestor of event information representing an event which occurred on the first reference time and in a period in which the event has the relation represented by the relation information, among the events included in the second data;
a structure data generation unit that generates structure data based on the substructure data, wherein the structure data represent a structure including relation information included in the second relation information group and event information included in the substructures, and in which the relation information has an ancestor/descendant relation with other relation information, and the relation information becomes an ancestor of event information representing an event which occurred in a period in which the event has the relation represented by the relation information with the occurrence time of the second event of interest included in the first data; and
a determination unit that determines whether the structure represented by the structure data is included in the second structure.
